(19) United States
(12) Patent Application Publication
(10) Pub. No.: US 2006/0097884 A1
(43) Pub. Date: May 11, 2006

(54) Rising-alarm generating apparatus, medium, and method

(75) Inventors: Woo-young Jang, Seoul (KR); Yeun-bae Kim, Suwon-si (KR); Jae-chan Park, Yongin-si (KR); Jeong-le Park, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/263,839

(22) Filed: Nov. 2, 2005

(30) Foreign Application Priority Data
Nov. 8, 2004 (KR) 10-2004-0090350

(51) Int. Cl. G08B 23/00

(52) U.S. Cl. 340/575

(57) ABSTRACT

A rising-alarm generating apparatus, medium, and method. The rising-alarm generating apparatus may include a sound collecting unit to collect peripheral sounds, a sleeping-sound extracting unit to extract a sleeping sound from the collected sounds, a signal converting unit to convert the extracted sleeping sound into a digital signal, a sleeping-sound comparing unit to compare the converted sleeping sound with a stored sleeping sound sample to check for similarities, an alarm-signal output unit to output a rising-alarm signal for waking the user, and an alarm-signal-output control unit to control the output of the alarm-signal output unit in accordance with the comparison result of the sleeping-sound comparing unit. As a result, it is possible to wake a user by monitoring the sleeping state of the user, and it is also possible to prevent snoring and sleep apnea.

### CROSS-REFERENCE TO RELATED APPLICATIONS

This application claims the priority benefit of Korean Patent Application No. 10-2004-0090350, filed on Nov. 8, 2004, in the Korean Intellectual Property Office, the disclosure of which is incorporated herein in its entirety by reference.

### BACKGROUND OF THE INVENTION

1. Field of the Invention

Embodiments of the present invention relate to an apparatus, medium, and method for monitoring the sleep of a person, and more particularly to a rising-alarm generating apparatus, medium, and method which can wake a person by detecting their snoring sounds.

2. Description of the Related Art

Snoring occurs when a sleeper's throat narrows and prevents air from passing in and out easily. Snoring indicates respiratory distress while sleeping.

It has been found that 25 to 45% of normal adults snore. When the airway is completely blocked by severe muscle relaxation during sleep, heavy obesity, or other causes, air cannot reach the lungs. This phenomenon is called sleep apnea, and appears in 5 to 10% of normal adults. Sleep apnea prevents the lungs from obtaining fresh air, and when the brain senses such a state, it wakes the body and contracts muscles to open the airway, allowing the lungs to breathe again.

Since snorers suffer from lack of sleep, they are not refreshed in the morning and easily become drowsy during the day. Therefore, they may have poor concentration, with diminished skills and achievements. In addition, they are at risk of car accidents. Socially, snorers may easily become passive and introspective in human relations. When severe snoring develops into sleep apnea, sufferers can also be easily attacked by heart diseases, such as hypertension, angina pectoris, myocardial infarction, etc., or other adult diseases such as diabetes, liver failure, etc.

In the past, medical treatments and correction of sleeping postures were used to suppress snoring and sleep apnea.

However, one's sleeping posture is hard to control while asleep, and snoring or sleep apnea cannot be treated without the help of others.

Even those unaffected by snoring or sleep apnea may fall asleep during study or work, and it is difficult for them to get up at the intended time without the help of others.

### SUMMARY OF THE INVENTION

### Embodiments of the present invention set forth a rising-alarm generating apparatus, medium, and method to sense a user's sleeping state and wake the user.

To achieve the above and/or other aspects and advantages,: embodiments of the present invention include a rising-alarm generating apparatus, including a sound collecting unit to collect peripheral sounds, a sleeping-sound extracting unit to extract a sleeping sound from the collected peripheral sounds, a sleeping-sound comparing unit to compare the sleeping sound with a stored sleeping sound sample for similarities, an alarm-signal output unit to output a rising-alarm signal, and an alarm-signal-output control unit to control the output of the rising-alarm signal from the alarm-signal output unit in accordance with a comparison result of the sleeping-sound comparing unit.

The rising-alarm generating apparatus may further include a signal converting unit to convert the extracted sleeping sound into a digital signal.

The sleeping-sound extracting unit may extract a snoring or sleep apnea sound as the sleeping sound., and the sleeping-sound extracting unit may amplify the extracted sleeping sound. The sleeping-sound comparing unit may also store the sleeping-sound sample in an internal memory or in an external memory.

The alarm-signal output unit may output a sound signal, a vibration signal, or an optical signal, as the rising-alarm signal.

In addition, the alarm-signal-output control unit may control an operation start and/or operation end of the rising-alarm generating apparatus for a predetermined time period at predetermined intervals. The alarm-signal-output control unit may control the operation start and operation end of the sound collecting unit and an image collecting unit to collect peripheral images, in response to the operation start and/or the operation end of the rising-alarm generating apparatus.

In addition, the alarm-signal-output control unit may control the alarm-signal output unit to continuously output the rising-alarm signal while the sleeping sound is continuously collected.

The rising-alarm generating apparatus may include an operation button for inputting an operation starting instruction and/or an operation ending instruction. The alarm-signal-output control unit may control an operation start and/or operation end of the rising-alarm generating apparatus in response to the operation starting instruction and the operation ending instruction input through the operation button. The operation button may serve to input an output stopping instruction indicating that the output of the rising-alarm signal from the alarm-signal output unit should be stopped.

The rising-alarm generating apparatus may include an alarm-signal determining unit to designate a type of rising-alarm signal output from the alarm-signal output unit based on peripheral environment information, in response to a control signal from the alarm-signal-output control unit. The alarm-signal determining unit may designate the type of rising-alarm signal in accordance with a user's selection. The alarm-signal determining unit may detect the peripheral environment information from image information collected by an image collecting unit which collects peripheral images and sound information collected by the sound collecting unit.

The alarm-signal determining unit may further designate an optical signal as the rising-alarm signal when it is determined that a peripheral environment of the rising-alarm generating apparatus is darkness. The alarm-signal determining unit may still designate a sound signal as the rising-alarm signal when it is determined that a peripheral environment of the rising-alarm generating apparatus is silence. Similarly, the alarm-signal determining unit may designate a vibration signal as the rising-alarm signal when it is determined that a peripheral environment of the rising-alarm generating apparatus is a noisy environment.

The rising-alarm generating apparatus may further include a mobile phone, a notebook computer, or a personal digital assistant including the rising-alarm generating apparatus therein. The alarm-signal-output control unit may temporarily stop an operation of the rising-alarm generating apparatus when the rising-alarm generating apparatus is included in the mobile phone or the personal digital assistant, when radio communication is requested during the operation of the rising-alarm generating apparatus. Further, the alarm-signal output unit may be separable from the rising-alarm generating apparatus when the rising-alarm generating apparatus is included in the mobile phone, notebook computer, or personal digital assistant, and outputs the rising-alarm signal by performing radio communication with the rising-alarm generating apparatus.

To achieve the above and/or other aspects and advantages, embodiments of the present invention include a rising-alarm generating method including collecting peripheral sounds, extracting a sleeping sound from the collected sounds, comparing the sleeping sound with a stored sleeping sound sample to check for similarities, and outputting a rising-alarm signal when the sleeping sound is determined to be similar to the stored sleeping sound sample.

The method may further include converting the extracted sleeping sound into a digital signal. In the extracting of the sleeping sound, a snoring or sleep apnea sound may be extracted as the sleeping sound. The extracting of the sleeping sound, the extracted sleeping sound may be amplified. In addition, in the outputting of the rising-alarm signal, a sound signal, a vibration signal, or an optical signal may be output as the rising-alarm signal.

The method may include determining a type of rising-alarm signal to output based on peripheral environmental information and performing the outputting of the rising-alarm signal, after the comparing of the converted sleeping sound with the stored sleeping sound sample. In the determining of the type of rising-alarm signal, the type of rising-alarm signal may be designated in accordance with a user's selection. In addition, in the determining of the type of the rising-alarm signal, the peripheral environmental information may be detected from image information and/or sound information of the peripheral environment. Here, in the determining of the type of rising-alarm signal, an optical signal may be designated as the rising-alarm signal when it is determined that a peripheral environment of a corresponding rising-alarm generating apparatus is darkness. Further, in the determining of the type of rising-alarm signal, a sound signal may designated as the rising-alarm signal when it is determined that a peripheral environment of a corresponding rising-alarm generating apparatus is silence. In the determining of the type of rising-alarm signal, a vibration signal may be designated as the rising-alarm signal when it is determined that a peripheral environment of a corresponding rising-alarm generating apparatus is a noisy environment.

The method may further include checking whether the sleeping sound is continuously collected, after the outputting of the rising-alarm signal. The rising-alarm generating method may be performed for a predetermined time period at predetermined intervals.

The operation of the rising-alarm generating method may be started and/or ended in response to an operation starting instruction and an operation ending instruction.

The rising-alarm generating method may further be executed in a mobile phone, a notebook computer, or a personal digital assistant.

To achieve the above and/or other aspects and advantages, embodiments of the present invention include a mobile phone, a notebook computer, or a personal digital assistant implementing embodiments of the present invention.

To achieve the above and/or other aspects and advantages, embodiments of the present invention include at least one medium including computer readable code/instructions to implement embodiments of the present invention.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following descriptions of embodiments, taken in conjunction with the accompanying drawings of which:

FIG. 1 illustrates a rising-alarm generating apparatus, according to an embodiment of the present invention;

FIGS. 2A to 2C illustrate alarm-signal output embodiments of a rising-alarm generating apparatus; and

FIG. 3 illustrates a flowchart of a rising-alarm generating method, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the FIGUREs.

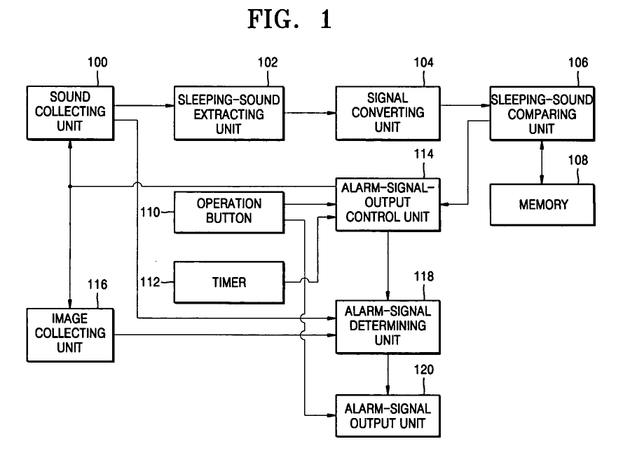

FIG. 1 illustrates a rising-alarm generating apparatus, according to an embodiment of the present invention. The rising-alarm generating apparatus may include a sound collecting unit 100, a sleeping-sound extracting unit 102, a signal converting unit 104, a sleeping-sound comparing unit 106, a memory 108, an operation button 110, a timer 112, an alarm-signal-output control unit 114, an image collecting unit 116, an alarm-signal determining unit 118, and an alarm-signal output unit 120.

The sound collecting unit 100 may collect peripheral sounds and output the collected sounds to the sleeping-sound extracting unit 102. The sound collecting unit 100 may be a device such as a microphone, for example, which can collect peripheral human voices, sounds, noises, etc. The sound collecting unit 100 may perform a sound collecting function in response to a control signal indicating operation start from the alarm-signal-output control unit 114, as described in greater detail below.

The sleeping-sound extracting unit 102 can extracts a human sleeping sound from the collected sounds, e.g., in response to the input of the sounds collected by the sound collecting unit 100, and then output the extracted sleeping sound to the signal converting unit 104. The sleeping sounds may include sounds of constant patterns, which can be generated during a person's sleep, such as the sounds of snoring and sleep apnea. The sound of snoring is typically emitted when a sleeper's throat narrows, preventing air from passing in and out easily. The sound of sleep apnea is emitted when the airway is completely blocked and air cannot reach the lungs. That is, the sound of sleep apnea is a respiratory pattern generated when the brain senses the throat blockage and wakes the body to recover breathing.

The sleeping-sound extracting unit 102 may extract the sleeping sound by using an analog filter, for example, to remove sounds other than the sleeping sounds such as the sound of snoring or sleep apnea from the collected sounds.

The sleeping-sound extracting unit 102 may preferably amplify the extracted sleeping sound. That is, the sleeping-sound extracting unit 102 can amplify the extracted sleeping sound using an amplifier and then output the amplified sleeping sound to the signal converting unit 104.

The signal converting unit 104 may convert the sleeping sound input from the sleeping-sound extracting unit 102 into a digital signal. The signal converting unit 104 can convert the analog sleeping sound signal into a digital signal for a digital process and then output the converted sleeping sound to the sleeping-sound comparing unit 106.

The sleeping-sound comparing unit 106 may compare the converted sleeping sound with a user's sleeping sound sample stored in advance, for example, to check the similarity. The sleeping sound sample is the sound of the user's snoring or sleep apnea, stored in advance in a memory space by the user of the rising-alarm generating apparatus. The user may intentionally make and store his sound of snoring or sleep apnea in advance, on the assumption that he is in a sleeping state. The user's sleeping sound sample can be in a digital form. If the sleeping sound, converted into a digital signal, is similar to the user's sleeping sound sample, it means that the person making the sleeping sound is the user of the rising-alarm generating apparatus.

The sleeping-sound comparing unit 106 may store and manage the user's sleeping sound sample in an internal memory of the sleeping-sound comparing unit 106, or in a particular memory 108 as shown in FIG. 1, for example. When receiving the sleeping sound from the signal converting unit 104, the sleeping-sound comparing unit 106 can read out the user's sleeping sound sample from the memory 108, in response to the sleeping sound, compare the sleeping sound input from the signal converting unit 104 with the sleeping sound read out from the memory 108 to check the similarity, and then output the comparison result to the alarm-signal-output control unit 114.

The memory 108 is a storage space to store the user's sleeping sound sample, for example. Such a memory 108 may be embodied as a particular memory or may be provided in the sleeping-sound comparing unit 106, for example.

The operation button 110 allows the user to input an operation starting instruction and an operation ending instruction to the rising-alarm generating apparatus. The user can give the operation starting instruction or the operation ending instruction of the rising-alarm generating apparatus, according to an embodiment of the present invention, through the operation button 110. Since power consumption is higher when the rising-alarm generating apparatus is always turned on, the user can determine the operation of the rising-alarm generating apparatus by using the operation button 110, for example. When the operation starting instruction or the operation ending instruction is input through the operation button 110, e.g., by the user, the operation starting instruction or the operation ending instruction can be output to the alarm-signal-output control unit 114.

On the other hand, the user may give the rising-alarm generating apparatus an output stopping instruction indicating that the output of the rising-alarm signal from the alarm-signal output unit 120 should be stopped, through the operation button 110. That is, when the rising-alarm signal is being output, the awoken user should be able to stop the output of the rising-alarm signal. The output stopping instruction for stopping the output of the rising-alarm signal may be input through the operation button 110, for example. When the output stopping instruction is input through the operation button 110, from the user, the output stopping instruction may be output to the alarm-signal output unit 120.

The timer 112 can supply time information to the alarm-signal-output control unit 114, such that the alarm-signal-output control unit 114 can control the operation of the rising-alarm generating apparatus over time.

The alarm-signal-output control unit 114 can control an operation start and operation end, for example, in response to the operation starting instruction and the operation ending instruction. The user may then input the operation start instruction and the operation end instruction to the rising-alarm generating apparatus through the operation button 110. The operation start instruction and the operation end instruction, can be transmitted to the alarm-signal-output control unit 114. The alarm-signal-output control unit 114 can then control the operation start and the operation end of the rising-alarm generating apparatus in response to the transmitted operation starting instruction and operation ending instruction.

The alarm-signal-output control unit 114 may control the operation start and the operation end for a predetermined time period, e.g., at predetermined intervals, by using the timer 112. For example, the alarm-signal-output control unit 114 may be able to allow the rising-alarm generating apparatus to operate for 5 minutes at intervals of 20 minutes by using the time information supplied from the timer 112, and not operate in the 15 minute periods outside these times. Further, for example, the alarm-signal-output control unit 114 may be able to allow the rising-alarm generating apparatus to operate for 6 hours from midnight to 6 O'clock at intervals of 24 hours, by using the time information supplied from the timer 112, and not to operate for the 18 hour periods outside the times described above, noting that alternative and additional embodiments are equally available.

At this time, the alarm-signal-output control unit 114 may preferably control the operation start and the operation end of the sound collecting unit 100 and the image collecting unit 116 collecting peripheral images, correspondingly to the operation start and the operation end of the rising-alarm generating apparatus. That is, when the rising-alarm generating apparatus starts its operation under the alarm-signal-output control unit 114, the sound collecting unit 100 and the image collecting unit 116 may receive a control signal for operation start from the alarm-signal-output control unit 114.

The sound collecting unit 100 may collect peripheral sounds after receiving the control signal for the operation start. The peripheral sounds collected by the sound collecting unit 100 may then be output to the alarm-signal determining unit 118.

The image collecting unit 116 can collect peripheral images after receiving the control signal for operation start. The peripheral images collected by the image collecting unit 100 can be output to the alarm-signal determining unit 118. For example, the image collecting unit 116 may be a camera. At this time, since a large amount of image information may be collected by the image collecting unit 116, the image collecting unit 116 may preferably collect only a predetermined number of image cuts for a predetermined time period.

The sound collecting unit 100 and the image collecting unit 116 may stop their operations after receiving the control signal for operation end, for example.

The alarm-signal-output control unit 114 can output a control signal, for controlling the output of the alarm-signal output unit 120, to the alarm-signal determining unit 118, in accordance with the comparison result of the sleeping-sound comparing unit 106. When the sleeping-sound comparing unit 106 indicates that the sleeping sound, e.g., converted into a digital signal, is similar to the user's sleeping sound sample, the alarm-signal-output control unit 114 may determine that the person emitting the sleeping sound is a known user of the rising-alarm generating apparatus, and may output to the alarm-signal determining unit 118 a control signal indicating that the person emitting the sleeping sound should be woken.

In addition, the alarm-signal-output control unit 114 may preferably control the alarm-signal output unit 120 to continuously output the rising-alarm signal while the sleeping sound is continuously collected, for example. The continuous collection of the sleeping sound means that the user stays asleep. Therefore, the alarm-signal-output control unit 114 may output the control signal such that the rising-alarm signal can be continuously output until the user wakes up.

The alarm-signal determining unit 118 may determine the kind of rising-alarm signal output from the alarm-signal output unit 120, e.g., based of the peripheral environment information, in response to the control signal from the alarm-signal-output control unit 114.

When receiving the control signal from the alarm-signal-output control unit 114, the alarm-signal determining unit 118 may receive the peripheral sound information collected by the sound collecting unit 100 and the peripheral image information collected by the image collecting unit 116, and detect the peripheral environment information therefrom, for example.

When determining that it is dark, e.g., based of the detected peripheral environment information, the alarm-signal determining unit 118 may determine an optical signal as the rising-alarm signal. The optical signal may include a flashing stimulation.

When determining that it is silent, e.g., based of the detected peripheral environment information, the alarm-signal determining unit 118 may determine a sound signal as the rising-alarm signal. Here, the sound signal may preferably not be loud enough to annoy others. A melody may also be used as the sound signal.

When determining that it is noisy, e.g., based on the detected peripheral environment information, the alarm-signal determining unit 118 may determine to use a vibration signal as the rising-alarm signal.

The alarm-signal determining unit 118 may designate one or more of the sound signal, the vibration signal, and the optical signal described above as the rising-alarm signal.

Further, the alarm-signal determining unit 118 may also designate the kind of rising-alarm signal in accordance with the user's selection. That is, the rising-alarm signal may be determined, in advance, in accordance with a user's selection, instead of the above-mentioned peripheral environment information.

The alarm-signal output unit 120 may output the rising-alarm signal to wake the user. The alarm-signal output unit 120 may output one or more of the sound signal, the vibration signal, and the optical signal determined by the alarm-signal determining unit 118, for example, as the rising-alarm signal. The alarm-signal output unit 120 may continuously output the rising-alarm signal until the sleeping sound is not collected, that is, until the user is awake, in response to the control signal of the alarm-signal-output control unit indicating for the continuous output of the rising-alarm signal.

When the user wakes up, the user can give the output stopping instruction, allowing the output of the rising-alarm signal to be stopped, through the above-mentioned operation button 110, for example. When receiving the output stopping instruction, the alarm-signal output unit 120 can stop the output of the rising-alarm signal in response to the output stopping instruction.

The rising-alarm generating apparatus may preferably be provided in a mobile phone, a notebook computer, or a personal digital assistant (PDA), noting additional embodiments are equally available.

Here, when the rising-alarm generating apparatus is provided in the mobile phone or the personal digital assistant, for example, and radio communication is required during the operation of the rising-alarm generating apparatus, the alarm-signal-output control unit 114 may preferably stop the operation of the rising-alarm generating apparatus. For example, assuming that the rising-alarm generating apparatus is provided in the mobile phone, and the rising-alarm generating apparatus is operating, when an audio call is received from another party by wireless network, then, the alarm-signal-output control unit 114 may temporarily stop the operation of the rising-alarm generating apparatus and permit the audio communication, as an intrinsic function of the mobile phone.

On the other hand, when the rising-alarm generating apparatus is provided in the mobile phone, notebook computer, or personal digital assistant, the alarm-signal output unit 120 may be separated from the rising-alarm generating apparatus. In this case, the alarm-signal output unit 120 may output the rising-alarm signal through the radio communication with the rising-alarm generating apparatus.

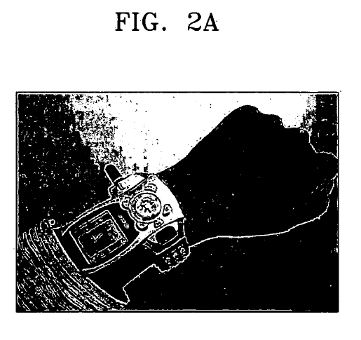

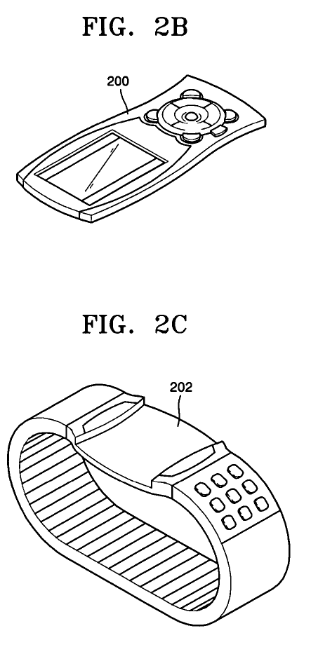

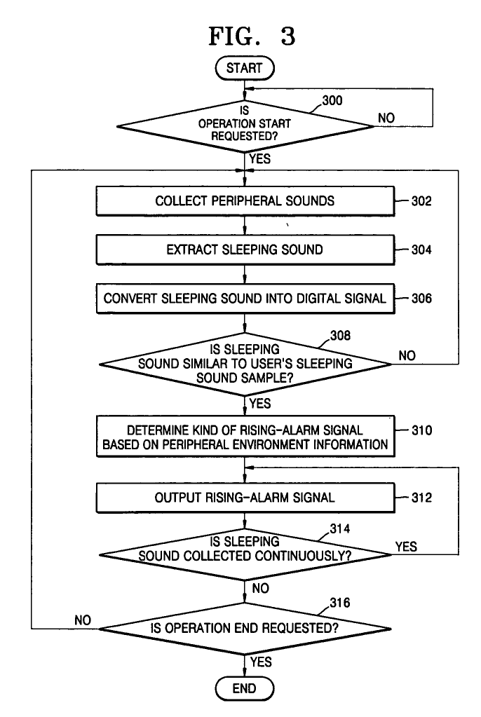

FIGS. 2A to 2C illustrate how the alarm-signal output unit 120 of the rising-alarm generating apparatus can be provided in a mobile phone and separated from the mobile phone. FIG. 2A illustrates a mobile phone 200 and an alarm-signal output unit 202 coupled to the mobile phone 200, mounted on a wrist. FIG. 2B illustrates an example of the alarm-signal output unit 202 separated from the mobile phone 200, and FIG. 2C illustrates an example of the mobile phone 200 separated from the alarm-signal output unit 202.

When a control signal indicating the output of the rising-alarm signal is transmitted to the alarm-signal output unit 202, from the alarm-signal-output control unit 114 provided in the mobile phone 200 shown in FIG. 2C, by wireless communication, the alarm-signal output unit 202 can output a rising-alarm signal, e.g., a sound signal, an optical signal, or a vibration signal, in accordance with the transmitted control signal.

A rising-alarm generating method, according to an embodiment of the present invention, will now be described in further detail with reference to the accompanying drawings.

FIG. 3 illustrates a rising-alarm generating method, according to an embodiment of the present invention.

As illustrated in FIG. 3, it can be checked whether an operation start of the rising-alarm generating apparatus is requested (operation 300). The operation start or the operation end of the rising-alarm generating apparatus may be automatically performed, for example, for a predetermined time period at predetermined intervals, or the operation start or the operation end of the rising-alarm generating apparatus may be performed in response to the operation starting instruction or the operation ending instruction from a user, for example.

If the operation start of the rising-alarm generating apparatus has been requested or initiated, the peripheral sounds may be collected (operation 302).

After operation 302, the human sleeping sound may be extracted from the collected sounds (operation 304). The sleeping sound may include sounds of constant patterns, which can be generated when a person sleeps, such as a user's snoring and sleep apnea sounds. The sleeping sound can be extracted by removing sounds from the collected sounds. At this time, the extracted sleeping sound may preferably be amplified.

After operation 304, for example, the extracted sleeping sound may be converted into a digital signal (operation 306).

The converted sleeping sound may be compared with a user's sleeping previously stored sound sample, to check for similarities (operation 308). The sleeping sound sample may be the sound of the user's snoring or sleep apnea, which are previously stored in a memory space, e.g., by the user of the rising-alarm generating apparatus. The user may intentionally make and store his snoring or sleep apnea sounds in advance, assuming that he is in a sleeping state. The user's sleeping sound sample may, thus, be in a digital form.

If the collected sleeping sound is similar to the user's stored sleeping sound sample, the type of rising-alarm signal can be determined based on the peripheral environment information (operation 310). If the sleeping sound, e.g., converted into a digital signal, is similar to the user's sleeping sound sample, it means that the person emitting the sleeping sound is a user of the rising-alarm generating apparatus.

The peripheral environment information may be detected from the peripheral image information and the peripheral sound information, for example. When it is determined that it is dark, e.g., based on the detected peripheral environment information, an optical signal can be designated as the rising-alarm signal. When it is determined that the peripheral environment represents silence, based on the detected peripheral environment information, a sound signal can be designated as the rising-alarm signal. When it is determined that the peripheral environment represents a noisy environment, based on the detected peripheral environment information, a vibration signal may be designated as the rising-alarm signal.

One or more of the sound signal, the vibration signal, and the optical signal described above can be designated as the rising-alarm signal, for example.

Further, the rising-alarm signal type may be designated in accordance with a user's selection. That is, the rising-alarm signal may be designated in advance in accordance with the user's selection, e.g., instead of the above-mentioned peripheral environment information.

The rising-alarm signal may be output (operation 312), with one or more of the sound signal, the vibration signal, and the optical signal being preferably output, for example, as the rising-alarm signal.

It may be determined whether the sleeping sound is continuously collected (operation 314). The continuous collection of the sleeping sound means that the user may have stayed asleep. When the sleeping sound is continuously collected, operation 312 may be repeatedly performed so as to continuously output the rising-alarm signal.

However, when the sleeping sound is not continuously collected, it can be determined whether the operation end of the rising-alarm generating apparatus has been requested (operation 316). As described above, the operation start or the operation end of the rising-alarm generating apparatus may be automatically performed for a predetermined time period at predetermined intervals, and/or the operation start or the operation end of the rising-alarm generating apparatus may be performed in response to the operation starting instruction or the operation ending instruction from the user. Therefore, when the operation end is not requested, the procedure may be advanced to operation 302, and the above-mentioned operations are performed again, but when the operation end is requested, the procedure may be finished, for example.

The aforementioned rising-alarm generating method may preferably be carried out in a mobile phone, a notebook computer, or a personal digital assistant, for example, noting that additional embodiments are equally available.

Here, when the rising-alarm generating apparatus is provided in a mobile phone or the personal digital assistant, for example, and radio communication of the mobile phone or the personal digital assistant is required, while performing the respective operations of the rising-alarm generating method, it may be preferable that the corresponding operation is temporarily stopped.

In addition to the above described embodiments, embodiments of the present invention can also be implemented through computer readable code/instructions in/on a medium, e.g., a computer readable medium. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. The media may also be a distributed network/media, so that the computer readable code is stored/transferred/implemented in a distributed fashion.

While embodiments of present invention have been particularly shown and described with reference to embodiments of the rising-alarm generating apparatus, medium, and method, these embodiments only exemplify the present invention. It will be understood by those skilled in the art that various changes in form and details may be made therein without departing from the spirit and scope of the present invention as defined by the following claims.

As described above, the rising-alarm generating apparatus, medium, and method, according to embodiments of the present invention can allow a user to get up by sensing the user's undesirable sleeping state.

When a user snores or shows sleep apnea, due to incorrect postures, etc., it is possible to correct the user's posture and to suppress the snore or the sleep apnea.

Although a few embodiments of the present invention have been shown and described, it would be appreciated by those skilled in the art that changes may be made in these embodiments without departing from the principles and spirit of the invention, the scope of which is defined in the claims and their equivalents.

1. A rising-alarm generating apparatus, comprising:
a sound collecting unit to collect peripheral sounds;
a sleeping-sound extracting unit to extract a sleeping sound from the collected peripheral sounds;
a sleeping-sound comparing unit to compare the sleeping sound with a stored sleeping sound sample for similarities;
an alarm-signal output unit to output a rising-alarm signal; and
an alarm-signal-output control unit to control the output of the rising-alarm signal from the alarm-signal output unit in accordance with a comparison result of the sleeping-sound comparing unit.

2. The rising-alarm generating apparatus of claim 1, further comprising a signal converting unit to convert the extracted sleeping sound into a digital signal.

3. The rising-alarm generating apparatus of claim 1, wherein the sleeping-sound extracting unit extracts a snoring or sleep apnea sound as the sleeping sound.

4. The rising-alarm generating apparatus of claim 1, wherein the sleeping-sound extracting unit amplifies the extracted sleeping sound.

5. The rising-alarm generating apparatus of claim 1, wherein the sleeping-sound comparing unit stores the sleeping-sound sample in an internal memory or in an external memory.

6. The rising-alarm generating apparatus of claim 1, wherein the alarm-signal output unit outputs a sound signal, a vibration signal, or an optical signal, as the rising-alarm signal.

7. The rising-alarm generating apparatus of claim 1, wherein the alarm-signal-output control unit controls an operation start and/or operation end of the rising-alarm generating apparatus for a predetermined time period at predetermined intervals.

8. The rising-alarm generating apparatus of claim 7, wherein the alarm-signal-output control unit controls the operation start and operation end of the sound collecting unit and an image collecting unit to collect peripheral images, in response to the operation start and/or the operation end of the rising-alarm generating apparatus.

9. The rising-alarm generating apparatus of claim 1, wherein the alarm-signal-output control unit controls the alarm-signal output unit to continuously output the rising-alarm signal while the sleeping sound is continuously collected.

10. The rising-alarm generating apparatus of claim 1, further comprising an operation button for inputting an operation starting instruction and/or an operation ending instruction.

11. The rising-alarm generating apparatus of claim 10, wherein the alarm-signal-output control unit controls an operation start and/or operation end of the rising-alarm generating apparatus in response to the operation starting instruction and the operation ending instruction input through the operation button.

12. The rising-alarm generating apparatus of claim 10, wherein the operation button serves to input an output stopping instruction indicating that the output of the rising-alarm signal from the alarm-signal output unit should be stopped.

13. The rising-alarm generating apparatus of claim 1, further comprising an alarm-signal determining unit to designate a type of rising-alarm signal output from the alarm-signal output unit based on peripheral environment information, in response to a control signal from the alarm-signal-output control unit.

14. The rising-alarm generating apparatus of claim 13, wherein the alarm-signal determining unit designates the type of rising-alarm signal in accordance with a user's selection.

15. The rising-alarm generating apparatus of claim 13, wherein the alarm-signal determining unit detects the peripheral environment information from image information collected by an image collecting unit which collects peripheral images and sound information collected by the sound collecting unit.

16. The rising-alarm generating apparatus of claim 14, wherein the alarm-signal determining unit designates an optical signal as the rising-alarm signal when it is determined that a peripheral environment of the rising-alarm generating apparatus is darkness.

17. The rising-alarm generating apparatus of claim 14, wherein the alarm-signal determining unit designates a sound signal as the rising-alarm signal when it is determined that a peripheral environment of the rising-alarm generating apparatus is silence

18. The rising-alarm generating apparatus of claim 14, wherein the alarm-signal determining unit designates a vibration signal as the rising-alarm signal when it is determined that a peripheral environment of the rising-alarm generating apparatus is a noisy environment.

19. The rising-alarm generating apparatus of claim 1, wherein the rising-alarm generating apparatus further comprises a mobile phone, a notebook computer, or a personal digital assistant including the rising-alarm generating apparatus therein.

20. The rising-alarm generating apparatus of claim 19, wherein the alarm-signal-output control unit temporarily stops an operation of the rising-alarm generating apparatus when the rising-alarm generating apparatus is comprised in the mobile phone or the personal digital assistant, when radio communication is requested during the operation of the rising-alarm generating apparatus.

21. The rising-alarm generating apparatus of claim 19, wherein the alarm-signal output unit is separable from the rising-alarm generating apparatus when the rising-alarm generating apparatus is comprised in the mobile phone, notebook computer, or personal digital assistant, and outputs the rising-alarm signal by performing radio communication with the rising-alarm generating apparatus.

22. A rising-alarm generating method comprising:
collecting peripheral sounds;
extracting a sleeping sound from the collected sounds;
comparing the sleeping sound with a stored sleeping sound sample to check for similarities; and
outputting a rising-alarm signal when the sleeping sound is determined to be similar to the stored sleeping sound sample.

23. The rising-alarm generating method of claim 22, further comprising converting the extracted sleeping sound into a digital signal.

24. The rising-alarm generating method of claim 23, wherein in the extracting of the sleeping sound, a snoring or sleep apnea sound is extracted as the sleeping sound.

25. The rising-alarm generating method of claim 23, wherein in the extracting the sleeping sound, the extracted sleeping sound is amplified.

26. The rising-alarm generating method of claim 23, wherein in the outputting of the rising-alarm signal, a sound signal, a vibration signal, or an optical signal is output as the rising-alarm signal.

27. The rising-alarm generating method of claim 23, further comprising:
determining a type of rising-alarm signal to output based on peripheral environmental information and performing the outputting of the rising-alarm signal, after the comparing of the converted sleeping sound with the stored sleeping sound sample.

28. The rising-alarm generating method of claim 27, wherein in the determining of the type of rising-alarm signal, the type of rising-alarm signal is designated in accordance with a user's selection.

29. The rising-alarm generating method of claim 27, wherein in the determining of the type of the rising-alarm signal, the peripheral environmental information is detected from image information and/or sound information of the peripheral environment.

30. The rising-alarm generating method of claim 29, wherein in the determining of the type of rising-alarm signal, an optical signal is designated as the rising-alarm signal when it is determined that a peripheral environment of a corresponding rising-alarm generating apparatus is darkness.

31. The rising-alarm generating method of claim 29, wherein in the determining of the type of rising-alarm signal, a sound signal is designated as the rising-alarm signal when it is determined that a peripheral environment of a corresponding rising-alarm generating apparatus is silence.

32. The rising-alarm generating method of claim 29, wherein in the determining of the type of rising-alarm signal, a vibration signal is designated as the rising-alarm signal when it is determined that a peripheral environment of a corresponding rising-alarm generating apparatus is a noisy environment.

33. The rising-alarm generating method of claim 23, further comprising:
checking whether the sleeping sound is continuously collected, after the outputting of the rising-alarm signal.

34. The rising-alarm generating method of claim 23, wherein the rising-alarm generating method is performed for a predetermined time period at predetermined intervals.

35. The rising-alarm generating method of claim 23, wherein the operation of the rising-alarm generating method is started and/or ended in response to an operation starting instruction and an operation ending instruction.

36. The rising-alarm generating method of claim 23, wherein the rising-alarm generating method is executed in a mobile phone, a notebook computer, or a personal digital assistant.

37. A mobile phone, a notebook computer, or a personal digital assistant implementing the rising-alarm generating method of claim 23.

38. At least one medium comprising computer readable code/instructions to implement the rising-alarm generating method of claim 23.
